(19) United States
(12) Patent Application Publication
(10) Pub. No.: US 2012/0176342 A1
(43) Pub. Date: Jul. 12, 2012

(54) POSITION DETECTION SYSTEM, DISPLAY PANEL, AND DISPLAY DEVICE

(75) Inventors: Masayuki Hata, Osaka (JP); Toshiaki Nakagawa, Osaka (JP); Toshiyuki Yoshimizu, Osaka (JP); Yukio Mizuno, Osaka (JP)

(73) Assignee: SHARP KABUSHIKI KAISHA, Osaka (JP)

(21) Appl. No.: 13/395,498

(22) PCT Filed: Apr. 13, 2010
(86) PCT No.: PCT/JP2010/056567

§ 371 Date: Mar. 12, 2012

(30) Foreign Application Priority Data
Sep. 15, 2009 (JP) 2009-213603

(51) Int. Cl. G06F 3/042

(52) U.S. Cl. 345/175

(57) ABSTRACT

In an LED unit (23U), a plurality of P (an integer of three or more) units of LEDs (23) are placed so as to be mutually spaced apart while facing a line sensor (22C), and to supply light by way of being lit sequentially to a placement space (MS) to be lit. A position detection unit (12) uses a triangulation method to detect the positions of one or more objects, such as fingers, on a coordinate map area (MA) from the changes in the amount of light received according to P or more shadows at a line sensor unit (22U) that have been generated by light of the plurality of LEDs (23) illuminating at most P−1 objects placed in the placement space (MS).

### TECHNICAL FIELD

The present invention relates to a position detection system for detecting the position of an object, to a display panel equipped with the position detection system (such as a liquid crystal display panel), and further to a display device equipped with the display panel (such as a liquid crystal display device).

### BACKGROUND ART

Liquid crystal display devices of recent years may be equipped with a touch panel in which various indications can be made in the liquid crystal display device by touching the device with a finger or the like. There are various mechanisms to how a position detection system works in order to detect an object such as a finger on such a touch panel.

For example, a touch panel 149 disclosed in Patent Document 1 shown in FIG. 16 is a position detection system using light, and is equipped with two light-emitting/receiving units 129 (129A and 129B). The light-emitting/receiving units 129 (129A and 129B) includes light receiving elements 122 (122A and 122B), light emitting elements (123A and 123B), and polygon mirrors 124 (124A and 124B). The light-emitting/receiving units 129 are disposed near the respective ends of a retroreflection sheet 131 enclosing the periphery of the touch panel 149, and supplies light emitted from the light emitting elements 123 to the retroreflection sheet 131 through the polygon minors 124.

Light reflected by the retroreflection sheet 131 is reflected by the polygon minors 124, and then enters the light receiving elements 122. However, when there is an object such as a finger (shielding object) S, the reflected light is blocked and does not enter the light receiving elements 122. Consequently, light reception data of the light receiving elements 122 includes the changes in an amount of light for the light being blocked. Therefore, a position of the object can be identified from the changes.

### RELATED ART DOCUMENTS

### Patent Documents

Patent Document 1: Japanese Patent Application Laid-Open Publication No. H11-143624

### SUMMARY OF THE INVENTION

### Problems to be Solved by the Invention

A position detection system in such a touch panel 149, however, can detect only one object such as a finger because the system is using only two light emitting/receiving units 129A and 129B. Moreover, the light-emitting/receiving units 129 includes a plurality of members such as the light receiving elements 122, the light emitting elements 123, and the polygon mirrors 124 within one unit, and therefore, the structure becomes complex and the cost is also increased due to the complex structure.

The present invention was devised in order to solve the above-mentioned problems. An object of the present invention is to provide a position detection system or the like that is simple and capable of detecting a plurality of objects such as fingers simultaneously.

### Means for Solving the Problems

A position detection system includes a light source unit including a plurality of light sources, a light receiving sensor unit receiving light of the light sources, and a position detection unit that detects a position of a shielding object, which is blocking light from the light sources, in accordance with the changes in an amount of light received at the light receiving sensors.

In this position detection system, the light receiving sensor unit includes two side-type linear light receiving sensors that are facing each other, and a bridge-type linear light receiving sensor that bridges between one of the side-type linear light receiving sensors and the other side-type linear light receiving sensor so that a space overlapping with an area enclosed by these linear light receiving sensors is a two-dimensional coordinate map area capable of identifying a position of the shielding object in accordance with the changes in an amount of light received.

The light source unit includes P units (an integer of three or more) of light sources, and the light sources are placed so as to be mutually spaced apart while facing the bridge-type linear light receiving sensor and to supply light to the coordinate map area by way of being lit sequentially. Furthermore, the position detection unit uses a triangulation method to detect a position of one or more of the shielding objects on the coordinate map area from the changes in an amount of light received in accordance with P or more shadows at the linear light receiving sensor unit that have been generated by light of the plurality of the light sources illuminating at most (P−1) of the shielding objects placed on the coordinate map area.

For example, when three of the light sources are lit sequentially, and when a total of three or six shadows are generated at the linear light receiving sensor unit in response thereto, it is preferable that the position detection unit determines as positions of the shielding objects a part of the areas where intersections created by the following three kinds of connecting lines are densely located: connecting lines that connect one of the three light sources to the shadows at the linear light receiving sensor unit generated by light of the one of the three light sources; connecting lines that connect another one of the three light sources to the shadows at the linear light receiving sensor unit generated by light of the another light source; and connecting lines that connect the last one of the three light sources to the shadows at the linear light receiving sensor unit generated by light of last one of the three light sources.

Further, when one of the light sources is lit to generate two shadows simultaneously at the linear light receiving sensor unit, another one of the light sources is lit to generate two shadows simultaneously at the linear light receiving sensor unit, and yet another one of the light sources is lit to generate one shadow at the linear light receiving sensor unit so that a total of five shadows are generated, it is preferable that the position detection unit determine intersections satisfying the following (1) and (2) as positions of the shielding objects.

(1) Intersections generated between two lines of first connecting lines, which are formed by connecting one of the light sources simultaneously generating two shadows to the corresponding two shadows respectively, and two lines of second connecting lines, which are formed by connecting another one of the light sources simultaneously generating two shadows to the corresponding two shadows respectively.

(2) The intersections that overlap with an enclosed area in the coordinate map area that is enclosed by yet another light source and both ends of a width of the corresponding shadow at the linear light receiving sensor generated by light of the yet another light source.

Moreover, when one of the light sources is lit to generate two shadows simultaneously at the linear light receiving sensor unit, another one of the light sources is lit to generate one shadow at the linear light receiving sensor unit, and yet another one of the light sources is further lit to generate one shadow at the linear light receiving sensor unit so that a total of four shadows are generated, it is preferable that the position detection unit determine positions of the shielding objects in the following manner.

That is, it is preferable that the position detection unit determine, in respect to first to third enclosed areas in the following, that a part of an area where one of two first enclosed areas, a second enclosed area, and a third enclosed area overlap with one another, and a part of an area where the other one of the two first enclosed areas, the second enclosed area, and the third enclosed area overlap with one another are the positions of the shielding objects.

Here, two first enclosed areas in the coordinate map area that are respectively enclosed by one of the light sources and both ends of widths of the corresponding two shadows at the linear light receiving sensor unit generated by light of one of the light sources are defined as two of the first enclosed areas.

An enclosed area in the coordinate map area that is enclosed by the another one of the light sources and both ends of a width of the corresponding shadow at the linear light receiving sensor unit generated by the another one of the light sources is defined as the second enclosed area.

An enclosed area in the coordinate map area that is enclosed by the yet another one of the light sources and both ends of a width of the corresponding shadow at the linear light receiving sensor unit generated by light of the yet another light source is defined as the third enclosed area.

According to the position detection system described above, it is possible to detect two objects simultaneously by only including, structure-wise, a simple linear light receiving sensor unit and a simple light source unit including a plurality of light sources, for example. Therefore, a liquid crystal display panel equipped with this position detection system, that is, a touch panel, can recognize gesture movements using two objects (such as fingers).

Moreover, because this touch panel has a relatively simple structure, it is possible to suppress an increase in costs of the touch panel.

### Effects of the Invention

It is possible to achieve a reduction in costs because the position detection system of the present invention can detect a plurality of objects such as fingers simultaneously and the structure is simple.

### BRIEF DESCRIPTION OF THE DRAWINGS

FIG. 1 is an explanatory view showing a plan view of a position detection system, and a block diagram of a microcomputer unit required to control this position detection system.

FIG. 2 is a partial cross-sectional view of a liquid crystal display device.

FIG. 3A is a plan view showing a line sensor unit.

FIG. 3B is a plan view showing a coordinate map area.

FIG. 4A is a plan view showing a placement space.

FIG. 4B is an explanatory view arranging a graph showing the signal intensity of the line sensor unit.

FIG. 5 is a plan view showing enclosed areas.

FIG. 6 is a plan view showing connecting lines.

FIG. 7A is a plan view showing the shadows of objects when an LED 23A emitted light.

FIG. 7B is a plan view showing the shadows of objects when an LED 23B emitted light.

FIG. 7C is a plan view showing the shadows of objects when an LED 23C emitted light.

FIG. 8 is a plan view mainly showing the connecting lines of FIGS. 7A to 7C.

FIG. 9A is a plan view showing the shadows of objects when the LED 23A emitted light.

FIG. 9B is a plan view showing the shadows of objects when the LED 23B emitted light.

FIG. 9C is a plan view showing the shadows of objects when the LED 23C emitted light.

FIG. 10 is a plan view mainly showing the connecting lines and enclosed areas of FIGS. 9A to 9C.

FIG. 11A is a plan view showing the shadows of objects when the LED 23A emitted light.

FIG. 11B is a plan view showing the shadows of objects when the LED 23B emitted light.

FIG. 11C is a plan view showing the shadows of objects when the LED 23C emitted light.

FIG. 12A is a plan view mainly showing the enclosed areas EAa12, EAb1, and EAc12 of FIGS. 11A to 11C.

FIG. 12B is a plan view mainly showing the enclosed areas EAa12, EAb2, and EAc12 of FIGS. 11A to 11C.

FIG. 12C is a plan view combining FIG. 12A and FIG. 12B.

FIG. 13A is a plan view showing the shadow of an object when the LED 23A emitted light.

FIG. 13B is a plan view showing the shadow of an object when the LED 23B emitted light.

FIG. 13C is a plan view showing the shadow of an object when the LED 23C emitted light.

FIG. 14 is a plan view mainly showing the connecting lines of FIGS. 13A to 13C.

FIG. 15 is a partial cross-sectional view of a liquid crystal display device.

FIG. 16 is a plan view showing a conventional touch panel.

### DETAILED DESCRIPTION OF EMBODIMENTS

### Embodiment 1

Embodiment 1 will be described below with reference to the figures. Here, members, hatchings, member characters and the like may be omitted for convenience, but in such cases, other figures should be referred to. For example, line sensors 22, which will be described later, may be illustrated by only light receiving chips CP. On the other hand, hatchings may be used for non-cross-sectional views for convenience. A black dot associated with arrow lines indicates the direction perpendicular to the plane of paper.

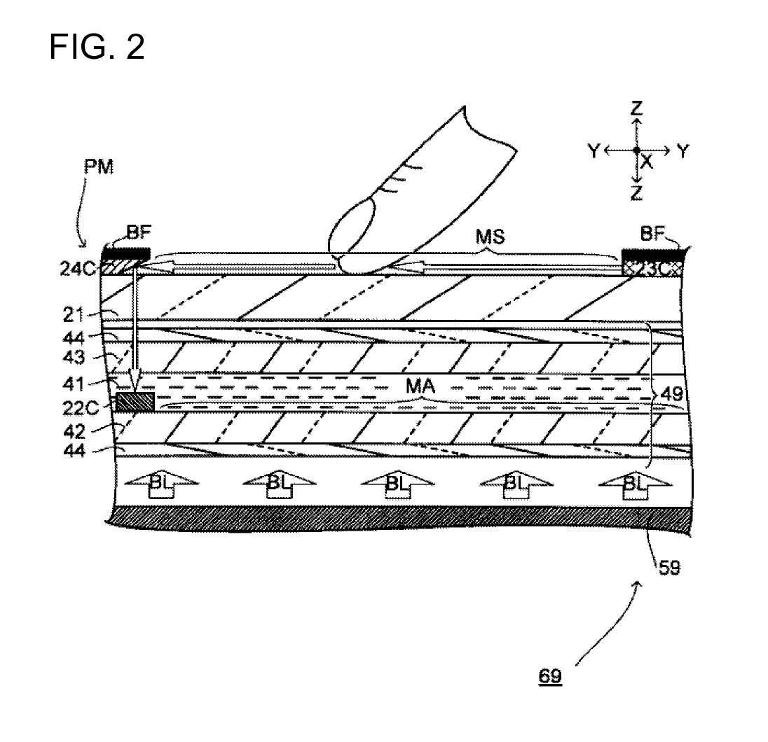

FIG. 2 is a partial cross-sectional view of a liquid crystal display device (display device) 69. As shown in this figure, the liquid crystal display device 69 includes a backlight unit (illumination device) 59 and a liquid crystal display panel (display panel) 49.

The backlight unit 59 is an illumination device equipped with light sources such as LEDs (Light Emitting Diodes) or fluorescent tubes, for example, and emits light (backlight light BL) onto the liquid crystal display panel 49, which is a non-light-emitting display panel.

The liquid crystal display panel 49, which receives light, includes an active matrix substrate 42 and an opposite substrate 43 sandwiching liquid crystal 41. Furthermore, although not shown in the figure, the active matrix substrate 42 has gate signal lines and source signal lines that are arranged so as to be perpendicular to each other, and a switching element (Thin Film Transistor, for example), which is required for adjusting a voltage applied to the liquid crystal (liquid crystal molecules) 41, is further disposed at the respective intersections of the two signal lines.

A polarizing film 44 is attached to a light receiving side of the active matrix substrate 42 and to an emission side of the opposite substrate 43. The above-mentioned liquid crystal display panel 59 displays images using the changes in transmittance caused by inclinations of the liquid crystal molecules 41 reacting to an applied voltage.

This liquid crystal display panel 49 is also equipped with a position detection system PM. The liquid crystal display panel 49 equipped with this position detection system PM may also be called a touch panel. This position detection system PM is a system that detects where a finger is located on the liquid crystal display panel 49 as shown in FIG. 2.

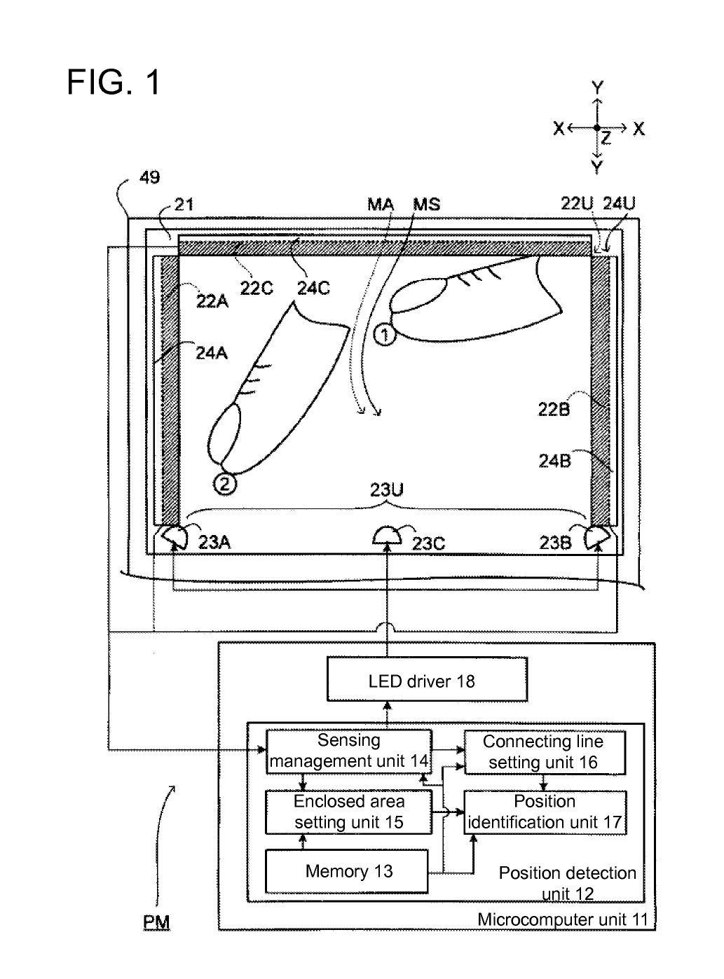

This position detection system PM will be described in detail with reference to FIGS. 1 and 2 (FIG. 1 is an explanatory view showing both a plan view of the position detection system PM and a block diagram of a microcomputer unit 11 that is required to control the position detection system PM).

The position detection system PM includes a protective sheet 21, a line sensor unit (light receiving sensor unit) 22U, an LED unit (light source unit) 23U, a reflective mirror unit 24U, and the microcomputer unit 11.

The protective sheet 21 is a sheet that covers the opposite substrate 43 (the polarizing film 44 on the opposite substrate 43 to be more specific) of the liquid crystal display panel 49. By being interposed between a finger and the display surface, this protective sheet 21 protects the liquid crystal display panel 49 from a scratch or the like, which could be caused when an object such as a finger is placed on the display surface side of the liquid crystal display panel 49.

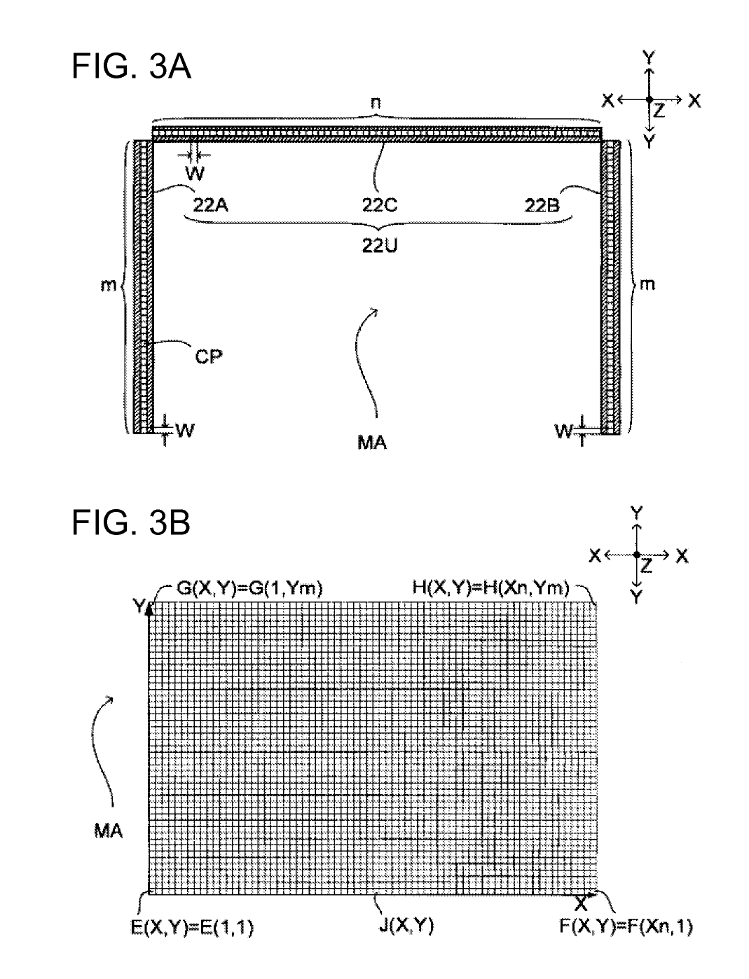

The line sensor unit 22U is a unit having three line sensors 22 (22A to 22C), each of which has light receiving chips CP (see FIG. 3A, which will be described later) arranged in a line. However, the three line sensors 22A to 22C may be formed unitarily as a continuous line. This line sensor unit 22U is disposed in the same layer as the liquid crystal 41, that is, between the active matrix substrate 42 and the opposite substrate 43, and has a light receiving surface thereof faces the opposite substrate 43. The mechanism of how they receive light will be explained later.

The line sensor unit 22U has the line sensors 22A to 22C arranged so as to enclose a certain area (enclosure shape). However, there is no special limitation to the arrangement shape of the line sensor unit 22U as long as it is an enclosure shape enclosing a certain area.

For example, the line sensor unit 22U includes, as shown in FIG. 1, the line sensor 22A and the line sensor 22B that are arranged opposite to each other, and the line sensor (bridge-type linear light receiving sensor) 22C, which bridges between the line sensor (side-type linear light receiving sensor) 22A and the line sensor (side-type linear light receiving sensor) 22B, so that the line sensors 22A to 22C are arranged in a “U” shape (“U” shape) enclosing a certain area. In other words, the line sensor 22A, the line sensor 22C, and the line sensor 22B are arranged in a continuous line so as to form a “U” shape.

A rectangular area enclosed by the line sensors 22A to 22C of the line sensor unit 22U is referred to as a coordinate map area MA, and a space overlapping with this coordinate map area MA and on which a finger or the like is placed is referred to as a placement space (coordinate map space) MS. Further, the direction in which the line sensor 22C is aligned is referred to as X direction, the direction in which the line sensors 22A and 22B are aligned is referred to as Y direction, and a direction crossing (such as a direction perpendicular to) X direction and Y direction is referred to as Z direction.

The LED unit 23U is a unit that has three LEDs 23 (23A to 23C) arranged in a line on the protective sheet 21. To explain in detail, the LED unit 23U is disposed such that the LEDs (point-like light sources) 23A to 23C are mutually spaced apart while facing the line sensor 22C. In other words, the LEDs 23A to 23C are arranged in a line along the direction in which the line sensor 22C is aligned (X direction), and are arranged so as to close an opening of the “U” shape, which is the arrangement shape of the line sensor unit 22U.

Then, light emitted from the LEDs 23A to 23C (source light) travels in a direction along the sheet surface of the protective sheet 21 (XY surface directions defined by X direction and Y direction), and the direction of the light faces toward the placement space MS (that is, a space on the protective sheet 21 overlapping with the coordinate map area MA), which overlaps with the coordinate map area MA enclosed by the line sensors 22A to 22C.

The reflective minor unit 24U is a unit that has three linear reflective mirrors 24 (24A to 24C) arranged in a manner similar to the line sensors 22A to 22C. To explain in detail, the reflective mirror unit 24U has a reflective minor 24A overlapping with the line sensor 22A, a reflective mirror 24B overlapping with the line sensor 22B, and a reflective minor 24C overlapping with the line sensor 22C on the protective sheet 21. In other words, the reflective mirror unit 24U encloses the placement space MS, which is located on the protective sheet 21 and which is overlapping with the coordinate map area MA, with the reflective minors 24A to 24C.

The LED 23A is disposed near one end of the reflective minor 24A that is not the end adjacent to the reflective minor 24C. In other words, the LED 23A is disposed near one end of the line sensor 22A that is not the end adjacent to the line sensor 22C. Therefore, light emitted from the LED 23A spreads throughout the area on the protective sheet 21 overlapping with the coordinate map area MA, that is, the placement space MS.

The LED 23B is disposed near one end of the reflective minor 24B that is not the end adjacent to the reflective minor 24C. In other words, the LED 23B is disposed near one end of the line sensor 22B that is not the end adjacent to the line sensor 22C. Therefore, light emitted from the LED 23B spreads throughout the area on the protective sheet 21 overlapping with the coordinate map area MA.

The LED 23C is disposed between one end of the reflective mirror 24A and one end of the reflective mirror 24B. In other words, the LED 23C is disposed between one end of the line sensor 22A and one end of the line sensor 22B. Therefore, light emitted from the LED 23C spreads throughout the area on the protective sheet 21 overlapping with the coordinate map area MA.

Furthermore, the reflective mirror unit 24U on the protective sheet 21 is arranged such that the minor surface of the reflective minor 24A faces the light receiving surface of the line sensor 22A while being inclined so as to receive light from the LED unit 23U; the minor surface of the reflective mirror 24B faces the light receiving surface of the line sensor 22B while being inclined so as to receive light from the LED unit 23U; and the minor surface of the reflective mirror 24C further faces the light receiving surface of the line sensor 22C while being inclined so as to receive light from the LED unit 23U.

This way, the reflective mirror unit 24U guides light traveling in the placement space MS on the protective sheet 21 toward the line sensor unit 22U. As a result, the line sensor unit 22U receives light traveling in the placement space MS.

Moreover, it is desirable if a light-shielding film BF is attached to the reflective minor unit 24U (that is, the reflective minors 24A to 24C) and the LED unit 23U (that is, the LEDs 23A to 23C) in order to suppress light leakage to the outside. For example, as shown in FIG. 2, it is desirable if a light-shielding film BF is attached to the outer surface of the reflective mirrors 24 facing outside and to the outer surface of the LEDs 23 facing outside.

The microcomputer unit 11 controls the position detection system PM, and includes an LED driver 18 and a position detection unit 12.

The LED driver 18 is a driver that supplies operation currents to the LEDs 23A to 23C of the LED unit 23U.

The position detection unit 12 includes a memory 13, a sensing management unit 14, an enclosed area setting unit 15, a connecting line setting unit 16, and a position identification unit 17.

The memory 13, when an object such as a finger is placed on the placement space MS, stores a coordinate map area MA for identifying a position of the finger or the like. A coordinate map area MA is prescribed by the number of light receiving chips CP that are embedded in the line sensors 22A to 22C arranged in a “U” shape as shown in FIG. 3A, for example.

For example, m units of the light receiving chips CP are included in the line sensor 22A, m units of the light receiving chips CP are included in the line sensor 22B, and n units of the light receiving chips CP are included in the line sensor 22C (here, n and m are both a plural number). In this line sensor unit 22U, the line sensors 22A and 22B that are arranged parallel to each other have the outermost light receiving chips CP of the line sensor 22A and the outermost light receiving chips CP of the line sensor 22B facing each other along the X direction. Further, the line sensor 22C bridges between the respective outermost light receiving chips CP of the line sensors 22A and 22B, which are facing each other.

Accordingly, a coordinate map area MA is sectioned by a large partitioned area formed by extending the width “W” of each of the light receiving chips CP in the line sensors 22A to 22C in a direction perpendicular to the directions in which the line sensors 22A to 22C including the respective light receiving chips CP are aligned.

To explain in detail, the width “W” of each of the light receiving chips CP in the line sensor 22A extends in X direction so as to become a large partitioned area with m units, and the width “W” of each of the light receiving chips CP in the line sensor 22B extends in X direction so as to become a large partitioned area with m units. Here, a large partitioned area based on the light receiving chips CP included in the line sensor 22A matches a large partitioned area based on the light receiving chips CP included in the line sensor 22B. The width “W” of each of the light receiving chips CP in the line sensor 22C extends in the Y direction so as to become a large partitioned area with n units.

When an area where these large partitioned areas are overlapping with each other is considered as a small grid unit, the coordinate map area MA is an area filled with the small grid units, as shown in FIG. 3B. In other words, a coordinate map area MA having small grid units in a matrix is formed. Because such a coordinate map area MA is formed, the position of a finger or the like on the placement space MS, which overlaps with this coordinate map area MA, can be identified.

The longitudinal direction of the rectangular coordinate map area MA is along X direction, and the short side direction is along Y direction. In the line sensor 22A and the line sensor 22C adjacent to each other, a small grid unit defined by a large grid unit area based on a light receiving chip CP located at an end of the line sensor 22A that is not the end adjacent to an end of the line sensor 22C, and a large grid unit area based on a light receiving chip CP located at an end of the line sensor 22C that is the end adjacent to an end of the line sensor 22A is referred to as a reference grid unit E, for convenience, and the position is indicated by E (X,Y)=E (1,1). Further, it can be interpreted that the emission point of the LED 23A overlaps with the position of this reference grid unit E.

A grid unit that is located on Y direction (Y coordinates) same as the reference grid unit E and that is located at the maximum position on X direction (X coordinates) is referred to as a grid unit F, and the position is indicated by F (X,Y)=F (Xn,1) (n is the number same as the number of the light receiving chips CP in the line sensor 22C). Here, it can be interpreted that an emission point of the LED 23B overlaps with the position of this grid unit F, and that an emission point of the LED 23C overlaps with a grid unit (grid unit J) in the middle of the reference grid unit E and the grid unit F.

A grid unit that is located on X direction same as the reference grid unit E and that is the maximum position on Y direction is referred to as a grid unit G, and the position is indicated by G (X,Y)=F (1,Ym) (m is the number same as the number of the light receiving chips CP in the line sensors 22A and 22B). Furthermore, a section that is the maximum position on X direction as well as the maximum position on Y direction is referred to as a grid unit H, and the position is indicated by H (X,Y)=H (Xn,Ym).

The sensing management unit 14 controls the LED unit 23U through the LED driver 18, and determines a light reception state at the line sensor unit 22U through the line sensor unit 22U. To explain in detail, the sensing management unit 14 controls the light emission timing, light emission time and the like of the LEDs 23A to 23C by control signals, and counts the number of shadows generated at the line sensors 22A to 22C in accordance with values (signal intensity) of light reception signals of the line sensors 22A to 22C (the shadow counting step).

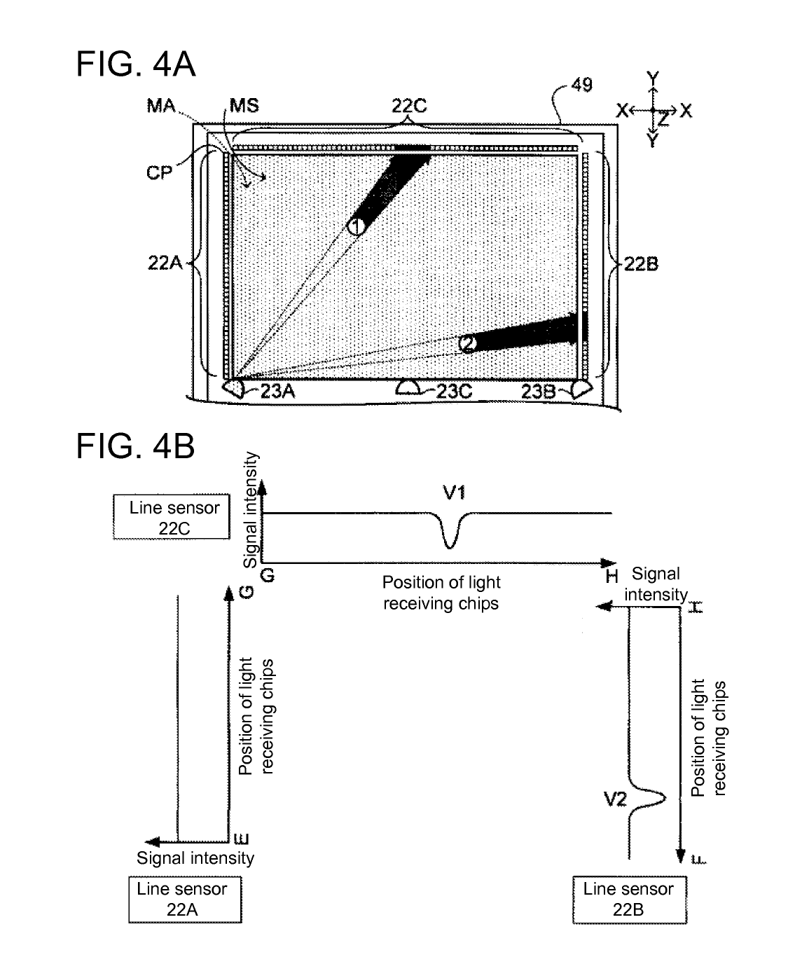

For example, as shown in FIG. 4A, when fingers or the like (objects (1) and (2)) on the placement space MS receive light from the LED unit 23U and shadows are created, the shadows extend along the directions in which light from the LED 23 travels, and reach the line sensors 22B and 22C of the line sensor unit 22U. Here, in FIG. 4A, areas with dark hatchings connected to the objects (shielding objects) (1) and (2) represent the shadows, the other areas with light hatchings represent the areas that are irradiated with light, and the LED 23A with hatchings indicates that it is emitting light.

Then, as shown in FIG. 4B, change areas V1 and V2 are generated in light reception data (light reception signals) of the line sensor unit 22U. Here, in the figure, the graph indicating the light reception data is positioned so as to correspond to the position of the line sensors 22A to 22C. The sensing management unit 14 counts the number of shadows overlapping with the line sensor unit 22U in accordance with the number of the change areas V1 and V2 generated in light reception data (signal intensity of the data signals) of the line sensor unit 22U.

The enclosed area setting unit 15 defines an enclosed area EA that is formed by connecting the shadows at the line sensor unit 22U to an LED 23 generating the shadows on the coordinate map area MA (the enclosed area setting step).

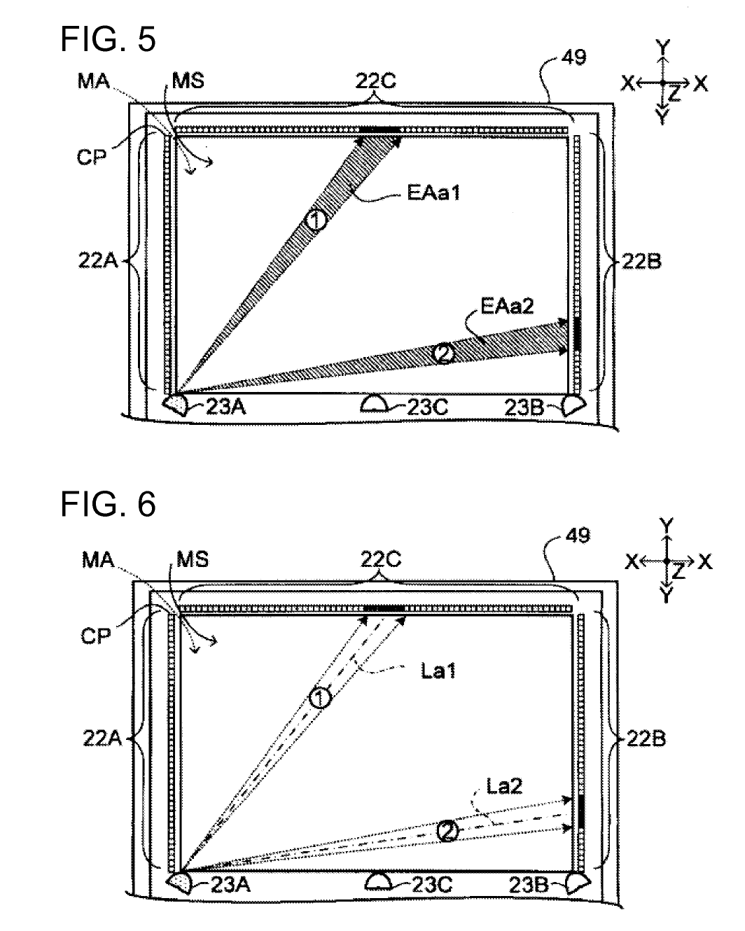

For example, as shown in FIG. 5, the enclosed area setting unit 15 defines an area (enclosed area EAa1) enclosed by the LED 23A, which is one of the light sources, and both ends of the width of a shadow at the line sensor 22C generated by light of the LED 23A. The enclosed area setting unit 15 also defines an area (enclosed area EAa2) enclosed by the LED 23A and both ends of the width of a shadow at the line sensor 22B generated by light of the LED 23A. Procedure to specify the positions of objects such as fingers using the enclosed areas (EAa1 and EAa2, for example) will be explained later in detail.

The connecting line setting unit 16 defines connecting lines L (La1 and La2, for example), within the coordinate map area MA, each of which connects a certain point of a shadow at the line sensor unit 22U to an LED 23 generating the shadow (the connecting line setting step). Here, as shown in FIG. 6, the certain point may be the middle point in the width direction of the shadow at the line sensors 22, that is, the middle point in the aligning direction of light receiving chips CP to which the shadow reaches, for example. A connecting line L, which connects this middle point to an LED 23, may be defined as a line that is extending through the LED 23 and divides an angle with the LED 23 as a vertex thereof in the enclosed area EA into two equal parts. Procedure to specify the positions of objects such as fingers using the connecting lines L (La1 and La2, for example) will be explained later in detail.

The position identification unit 17 identifies the positions of objects such as fingers using at least either the enclosed areas EA, which have been defined by the enclosed area setting unit 15, or the connecting lines L, which have been defined by the connecting line setting unit 16 (the position identification step). The detail of the step will be explained below.

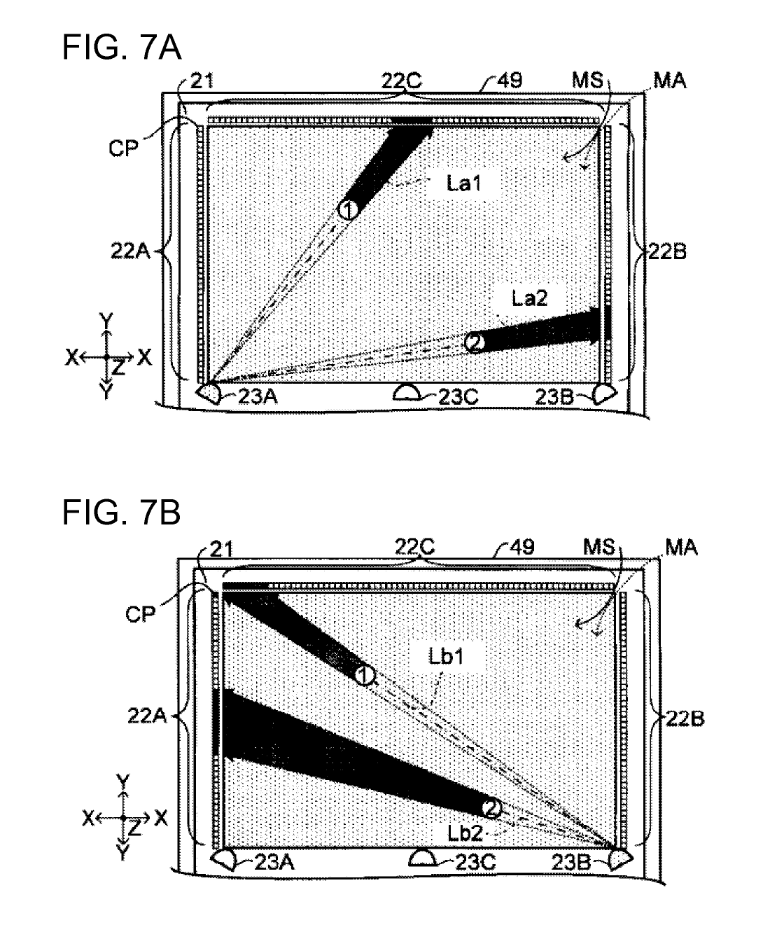

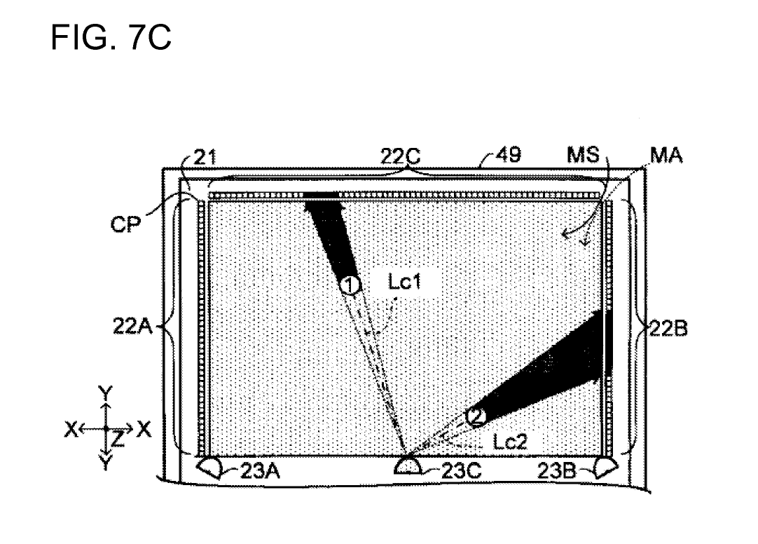

For example, when the sensing management unit 14 caused the LED 23A to emit light through the LED driver 18 as shown in FIG. 7A, and when the line sensor unit 22U detects shadows created by objects (1) and (2), the sensing management unit 14 determines from light reception data of the line sensor unit 22U that there are two shadows.

Next, when the sensing management unit 14 caused the LED 23B to emit light through the LED driver 18 as shown in FIG. 7B, and when the line sensor unit 22U detects shadows created by the objects (1) and (2), the sensing management unit 14 determines from light reception data of the line sensor unit 22U that there are two shadows.

Furthermore, when the sensing management unit 14 caused the LED 23C to emit light through the LED driver 18 as shown in FIG. 7C, and when the line sensor unit 22U detects shadows created by the objects (1) and (2), the sensing management unit 14 determines from light reception data of the line sensor unit 22U that there are two shadows.

In other words, the sensing management unit 14 causes the LEDs 23A to 23C to light up individually as well as sequentially, and counts the shadows of the objects (1) and (2) created by light of the respective LEDs 23A to 23C in accordance with light reception data of the line sensor unit 22U. The sensing management unit 14 further counts a total number of shadows generated by light of the respective LEDs 23A to 23C (the shadow counting step). As a result, when the objects (1) and (2) are positioned as shown in FIGS. 7A to 7C, the sensing management unit 14 determines that six shadows have been created.

Moreover, the sensing management unit 14 determines, based on data of the coordinate map area MA (map data) obtained from the memory 13, which grid units at the outermost linear areas of the coordinate map area MA the shadows occupy (see FIG. 3B).

To explain in detail, the sensing management unit 14 identifies which grid units the shadows occupy continuously at the linear grid unit area between the reference grid unit E and the grid unit G, the linear grid unit area between the grid unit G and the grid unit H, and the linear grid unit area between the grid unit H and the grid unit F (the identified grid unit data setting step). The sensing management unit 14 then sends the data of grid units identified on the coordinate map area MA (identified grid unit data) to the connecting line setting unit 16.

The connecting line setting unit 16 defines a connecting line L in the coordinate map area MA using the identified grid unit data sent from the sensing management unit 14. This connecting line L is a connecting line on the coordinate map area MA that connects one grid unit among a plurality of grid units indicating the width of a shadow, that is, the grid unit in the middle of the plurality of grid units arranged in a line indicating the shadow (identified grid unit data), to the grid unit indicating an emission point of the LED 23, for example.

For example, when the LED 23A emits light (see FIG. 7A), a grid unit in the middle of the respective grid units at both ends of the identified grid unit data indicating the shadow of the object (1) is connected to the reference grid unit E, which is a grid unit indicating an emission point of the LED 23A, to define a connecting line La1. Further, when the LED 23A emits light, a grid unit in the middle of the respective grid units at both ends of the identified grid unit data indicating the shadow of the object (2) is connected to the reference grid unit E, which is a grid unit indicating an emission point of the LED 23A, to define a connecting line La2.

Next, when the LED 23B emits light (see FIG. 7B), a grid unit in the middle of the respective grid units at both ends of the identified grid unit data indicating the shadow of the object (1) is connected to the grid unit F, which is a grid unit indicating an emission point of the LED 23B, to define a connecting line Lb1. Further, when the LED 23B emits light, a grid unit in the middle of the respective grid units at both ends of the identified grid unit data indicating the shadow of the object (2) is connected to the grid unit F, which is a grid unit indicating an emission point of the LED 23B, to define a connecting line Lb2.

Moreover, when the LED 23C emits light (see FIG. 7C), a grid unit in the middle of the respective grid units at both ends of the identified grid unit data indicating the shadow of the object (1) is connected to the grid unit J, which is a grid unit indicating an emission point of the LED 23C, to define a connecting line Lc1. Further, when the LED 23C emits light, a grid unit in the middle of the respective grid units at both ends of the identified grid unit data indicating the shadow of the object (2) is connected to the grid unit J, which is a grid unit indicating an emission point of the LED 23C, to define a connecting line Lc2.

As described above, the connecting line setting unit 16 defines six lines of connecting lines L (the connecting line setting step), and sends data indicating those connecting lines L (connecting line data) to the position identification unit 17.

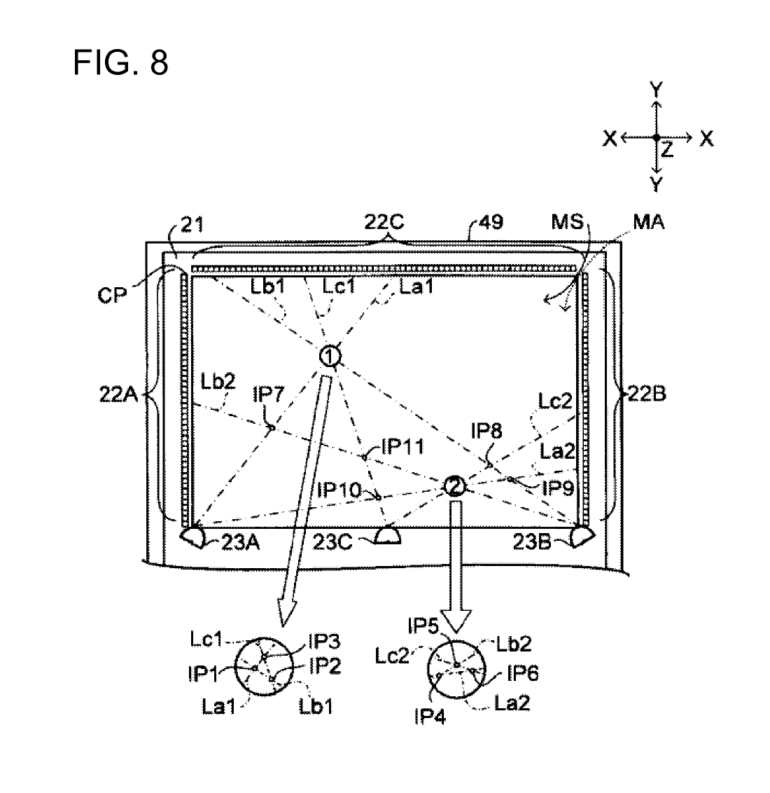

The position identification unit 17 identifies intersections of the respective connecting lines L in accordance with the connecting line data sent from the connecting line setting unit 16. Then, eleven intersections IP1 to IP11 are identified as shown in FIG. 8. The figures the white line arrows are pointing at are enlarged partial views. The positions of these intersections IP are identified by a triangulation method where the reference grid unit E is defined as a fixed point, and a line connecting the reference point E to the grid unit F (can also be referred to as X axis) is defined as a reference line, for example. Further, the position identification unit 17 identifies two places, among the eleven intersections IP, where three intersections IP are densely-located. A distance between each of the intersections IP that is considered dense can be determined as appropriate.

For example, the position identification unit 17 determines an intersection IP1 (intersection of the connecting line La1 and the connecting line Lb1), an intersection IP2 (intersection of the connecting line Lb1 and the connecting line Lc1), and an intersection IP3 (intersection of the connecting line Lc1 and the connecting line La1) as a densely-located place. Moreover, the position identification unit 17 determines an intersection IP4 (intersection of the connecting line La2 and the connecting line Lb2), an intersection IP5 (intersection of the connecting line Lb2 and the connecting line Lc2), and an intersection IP6 (intersection of the connecting line Lc2 and the connecting line La2) as another densely-located place. Then, these two places are identified as the positions of the objects (1) and (2) such as fingers (the position identification step).

In other words, the position detection unit 12 including the position identification unit 17 determines a part of the area where the intersections IP1 to IP3, which have been created by the connecting line La1 generated by the LED 23A, the connecting line Lb1 generated by the LED 23B, and the connecting line Lc1 generated by the LED 23C, are densely-located as the position of one object (1); and a part of the area where the intersections IP4 to IP6, which have been created by the connecting line La2 generated by the LED 23A, the connecting line Lb2 generated by the LED 23B, and the connecting line Lc2 generated by the LED 23C, are densely-located as the position of the other object (2).

When it is required to identify the positions of the objects (1) and (2) more specifically, the center of an area enclosed by the intersections IP, that is, the triangle area with the intersections IP1 to IP3 as vertices thereof, and the center of the triangle area with the intersections IP4 to IP6 as vertices thereof may be determined as the positions of the objects (1) and (2).

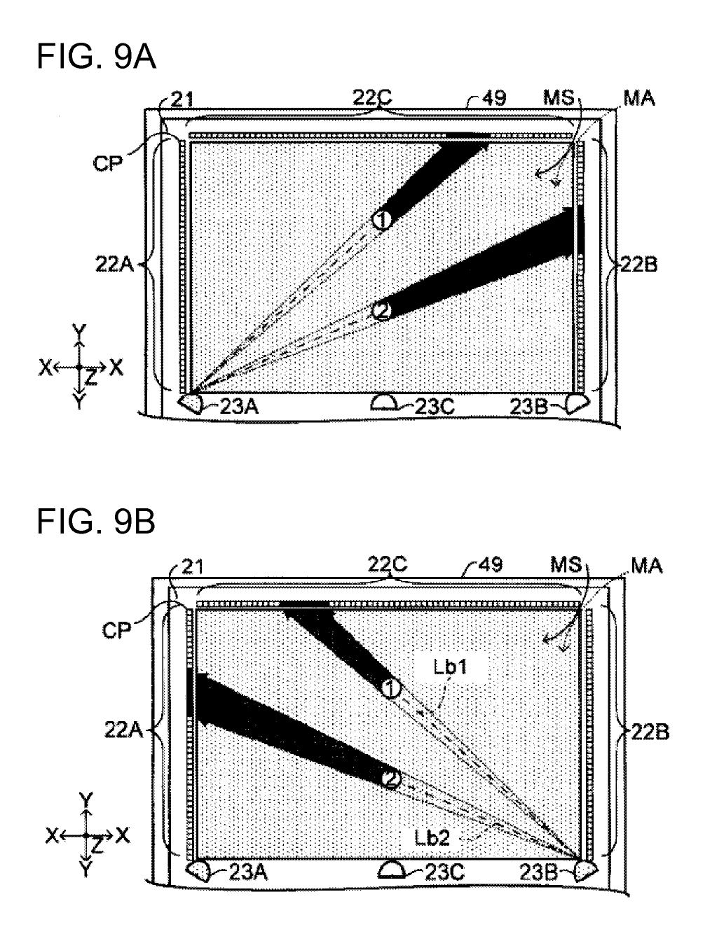

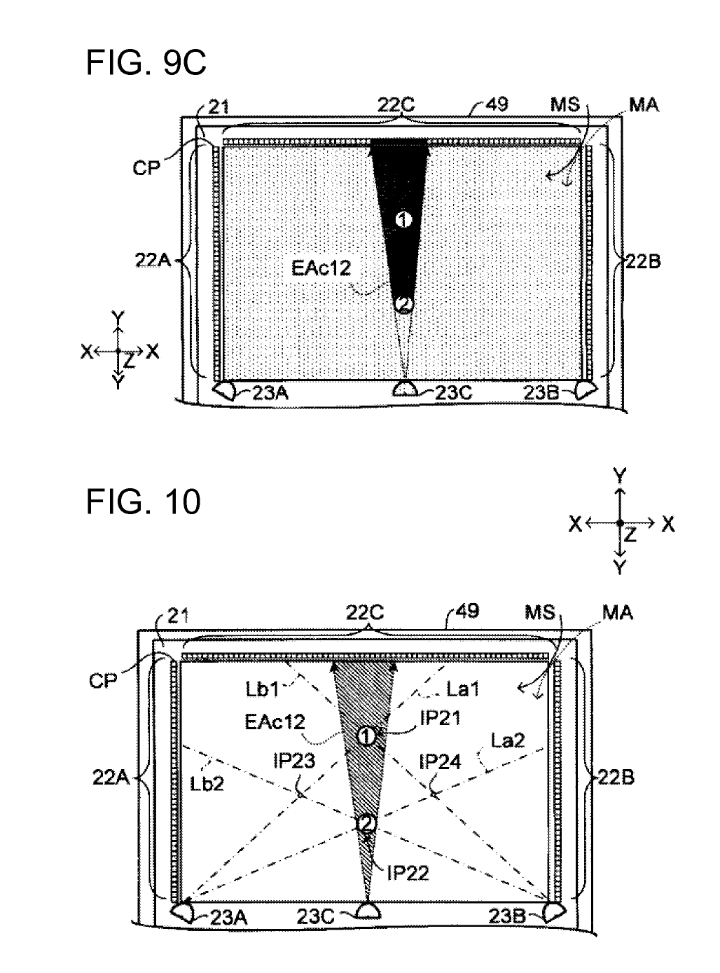

The number of shadows counted at the line sensor unit 22U differs depending on the positions of the objects (1) and (2). For example, beside the case where the LED 23A emits light and the sensing management unit 14 determines in accordance with light reception data of the line sensor unit 22U that there are two shadows as shown in FIG. 9A, and the case where the LED 23B emits light and the sensing management unit 14 determines in accordance with light reception data of the line sensor unit 22U that there are two shadows as shown in FIG. 9B, there is another case as shown in FIG. 9C.

That is, when the sensing management unit 14 caused the LED 23C to emit light through the LED driver 18 as shown in FIG. 9C, a case occurs where only one shadow is generated because the object (1) is located within the range of the shadow created by the object (2). In this case, the sensing management unit 14 determines in accordance with light reception data of the line sensor unit 22U that there is one shadow.

As shown in FIGS. 9A to 9C, the sensing management unit 14 causes the LEDs 23A to 23C to light up individually as well as sequentially, and counts the shadows of the objects (1) and (2) generated by light of the respective LEDs 23A to 23C in accordance with light reception data of the line sensor unit 22U. Then, the sensing management unit 14 determines that there are a total of five shadows generated by light of the respective LEDs 23A to 23C (the shadow counting step).

The sensing management unit 14 further obtains identified grid unit data indicating which grid units in the outermost linear area of the coordinate map area MA the shadows occupy (the identified grid unit data setting step), and sends the identified grid unit data to the connecting line setting unit 16 and the enclosed area setting unit 15. To explain in detail, the sensing management unit 14 sends two identified grid unit data in accordance with light emitted from the LED 23A and two identified grid unit data in accordance with light emitted from the LED 23B to the connecting line setting unit 16, and sends one identified grid unit data in accordance with light emitted from the LED 23C to the enclosed area setting unit 15. The destination of identified grid unit data is specified by the sensing management unit 14 according to the number of shadows.

The connecting line setting unit 16 defines connecting lines L using identified grid unit data sent from the sensing management unit 14. In other words, the connecting line setting unit 16 defines the connecting lines La1 and La2 (first connecting lines) based on identified grid unit data according to light emitted from the LED 23A, and the connecting lines Lb1 and Lb2 (second connecting lines) based on identified grid unit data according to light emitted from the LED 23B (the connecting line setting step). The connecting line setting unit 16 then sends data of the four connecting lines to the position identification unit 17.

The enclosed area setting unit 15 defines an area (enclosed area EAc12) enclosed by the LED 23C, which is one of the light sources, and both ends of the width of a shadow at the line sensor unit 22U generated by light emitted from the LED 23C (the enclosed area setting step). To explain in detail, the enclosed area EAc12 is defined by the grid unit J, which is the grid unit indicating an emission point of the LED 23C, and two outermost grid units indicated in identified grid unit data according to light emitted from the LED 23C. In other words, a connecting line that connects the grid unit J to one of the outermost grid units in the identified grid unit data is defined, and a connecting line that connects the grid unit J to the other outermost grid unit in the identified grid unit data is also defined.

The enclosed area setting unit 15 obtains an enclosed area EAc12 in such a manner, and sends the enclosed area data that is the data indicating the enclosed area EAc12 (in other words, connecting line data and identified grid unit data corresponding to the periphery of the enclosed area EAc12) to the position identification unit 17.

The position identification unit 17 identifies intersections of the respective connecting lines L in accordance with the connecting line data sent from the connecting line setting unit 16. Then, as shown in FIG. 10, four intersections IP21 to IP24 are identified. The position identification unit 17 further identifies, among the four intersections IP21 to IP24, the intersections IP that overlap with the enclosed area EAc12 in accordance with the enclosed area data sent from the enclosed area setting unit 15 (the position identification step).

For example, the position identification unit 17 determines that an intersection IP21 (intersection of the connecting line La1 and the connecting line Lb1) and an intersection IP22 (intersection of the connecting line La2 and the connecting line Lb2) are the intersections IP overlapping with the enclosed area EAc12. Then, these two intersections IP21 and IP22 are identified as the positions of the objects (1) and (2) such as fingers.

That is, the position detection unit 12 including the position identification unit 17 identifies the intersections IP21 to IP24 where two connecting lines La1 and La2 intersect with the two connecting lines Lb1 and Lb2. The connecting lines La1 and La2 are created by connecting the LED 23A, which generates two shadows simultaneously, to those two shadows respectively; and the connecting lines Lb1 and Lb2 are created by connecting the LED 23B, which generates two shadows simultaneously, to those two shadows respectively.

The position detection unit 12 further identifies, within the coordinate map area MA, the enclosed area EAc12 that is enclosed by the LED 23C and both ends of the width of a shadow at the sensor unit 22U according to light emitted from the LED 23C, and then the position detection unit 12 identifies the intersections IP overlapping with the enclosed area EAc12. Then, as shown in FIG. 10, these intersections IP21 and IP22 are identified as the positions of the objects (1) and (2) such as fingers.

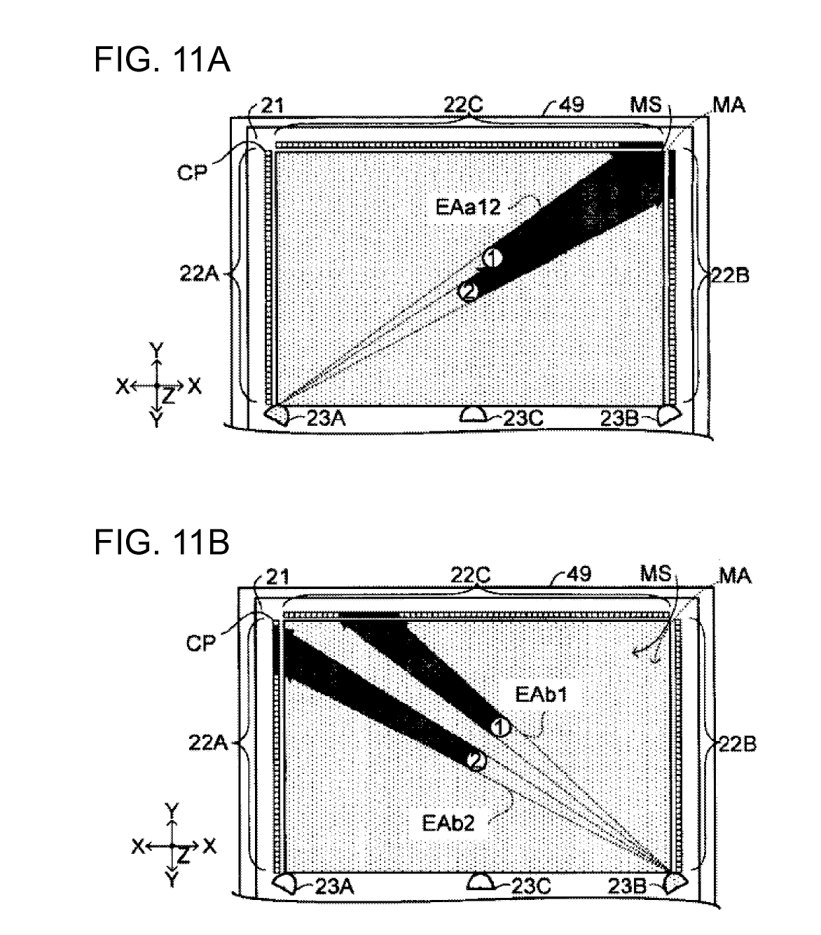

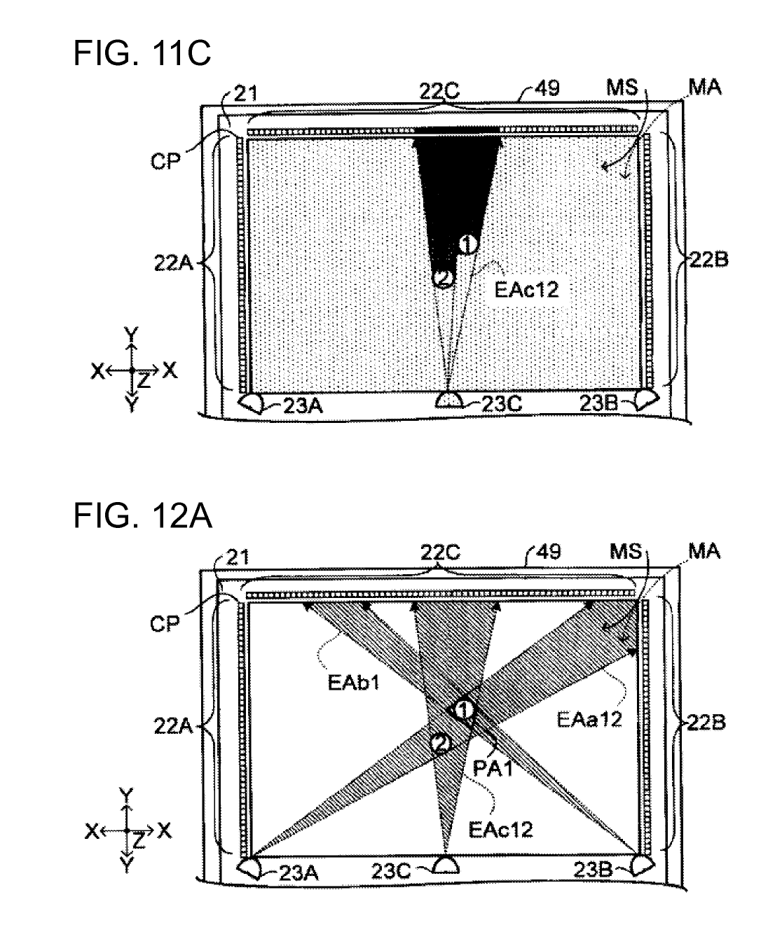

Moreover, beside the case shown in FIGS. 9A to 9C where the line sensor unit 22U detects only one shadow generated by light from the LED 23C that is one of the three LEDs 23, there is also a case shown in FIGS. 11A to 11C where the line sensor unit 22U detects only one shadow generated by light from the LED 23A and LED 23C that are two of the three LEDs 23.

In other words, as shown in FIGS. 11A to 11C, the sensing management unit 14 causes the LEDs 23A to 23C to light up individually as well as sequentially, and counts the shadows of objects (1) and (2) generated by light of the respective LEDs 23A to 23C in accordance with light reception data of the line sensor unit 22U. Then, the sensing management unit 14 determines that there are a total of four shadows generated by light of the respective LEDs 23A to 23C (the shadow counting step). The sensing management unit 14 further sends one identified grid unit data in accordance with light emitted from the LED 23A, two identified grid unit data in accordance with light emitted from the LED 23B, and one identified grid unit data in accordance with light emitted from the LED 23C to the enclosed area setting unit 15 (the identified grid unit data setting step).

The enclosed area setting unit 15 defines an area enclosed by the LED 23A and both ends of the width of a shadow at the line sensor unit 22U generated by the LED 23A (enclosed area EAa12). To explain in detail, the enclosed area EAa12 is defined by the reference grid unit E, which is a grid unit indicating an emission point of the LED 23A, and the two outermost grid units indicated in identified grid unit data according to light emitted from the LED 23A (the enclosed area setting step). In other words, a connecting line that connects the reference grid unit E to one of the outermost grid units in the identified grid unit data is defined, and a connecting line that connects the reference grid unit E to the other outermost grid unit in the identified grid unit data is also defined. The enclosed area setting unit 15 then sends the enclosed area data indicating this enclosed area EAa12 (second enclosed area) to the position identification unit 17.

The enclosed area setting unit 15 also defines areas that are respectively enclosed by the LED 23B and both ends of widths of two shadows at the line sensor unit 22U generated by light of the LED 23B (enclosed areas EAb1 and EAb2). To explain in detail, the enclosed areas EAb1 and EAb2 are defined by the grid unit F, which is a grid unit indicating an emission point of the LED 23B, and two outermost grid units indicated in the respective identified grid unit data according to light emitted from the LED 23B (the enclosed area setting step). In other words, connecting lines that respectively connect the grid unit F to an outermost grid unit in each of the identified grid unit data is defined, and connecting lines that respectively connect the grid unit F to the other outermost section in each of the identified grid unit data is also defined. The enclosed area setting unit 15 then sends the enclosed area data indicating these enclosed areas EAb1 and EAb2 (first enclosed areas) to the position identification unit 17.

The enclosed area setting unit 15 also defines an area (enclosed area EAc12) enclosed by the LED 23C and both ends of the width of a shadow at the line sensor unit 22U generated by light of the LED 23C (the enclosed area setting step). Then, the enclosed area setting unit 15 sends the enclosed area data indicating this enclosed area EAc12 (third enclosed area) to the position identification unit 17.

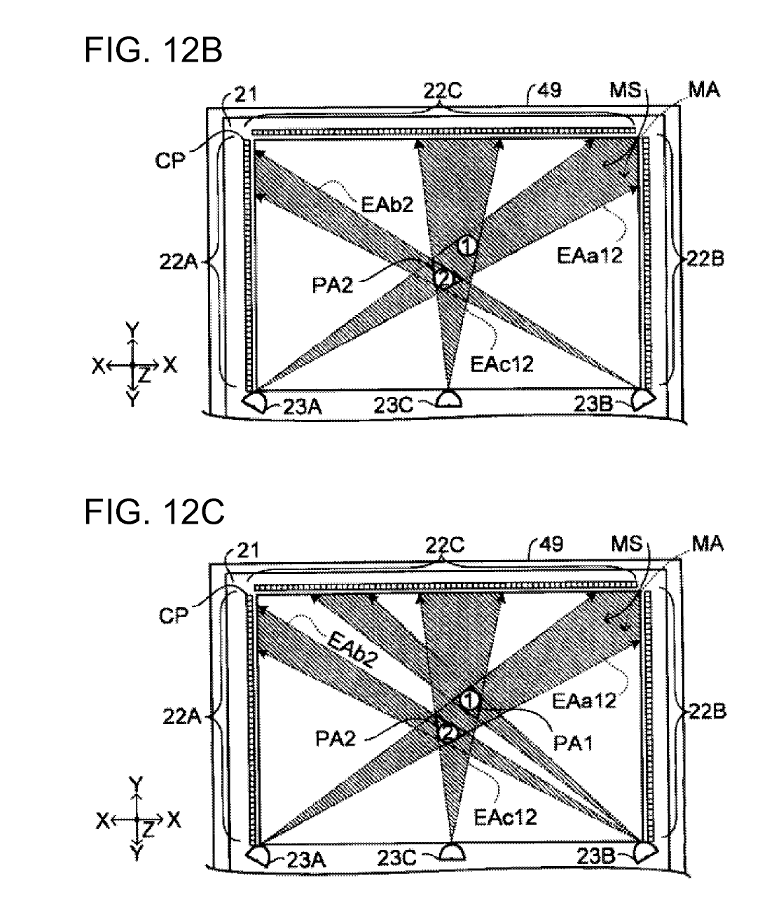

In accordance with the enclosed area data EA sent from the enclosed area setting unit 15, the position identification unit 17 identifies overlapped areas PA where different enclosed areas EA are overlapping with one another. For example, as shown in FIG. 12A, the position identification unit 17 identifies an area PA1 where the enclosed area EAa12 generated by the LED 23A, the enclosed area EAb1 that is one of the two enclosed areas EA generated by the LED 23B, and the enclosed area EAc12 generated by the LED 23C are overlapping with one another. Then, a range large enough to cover this overlapped area PA1 (a circle with a greatest diameter thereof covering the overlapped area PA1, for example) is identified as the position of the object (1) such as a finger (the position identification step).

The position identification unit 17 also identifies, as shown in FIG. 12B, an area PA2 where the enclosed area EAa12 generated by the LED 23A, the enclosed area EAb2 that is the other one of the two enclosed areas EA generated by the LED 23B, and the enclosed area EAc12 generated by the LED 23C are overlapping with one another. Then, a range large enough to cover this overlapped area PA2 is identified as the position of the object (2) such as a finger (the position identification step).

In other words, the position detection unit 12 including the position identification unit 17 defines two enclosed areas EAb1 and EAb2, which are respectively enclosed by the LED 23B and both ends of widths of the respective two shadows at the line sensor unit 22U generated by light of the LED 23B, on the coordinate map area MA.

The position detection unit 12 also defines an enclosed area EAa12, which is enclosed by the LED 23A and both ends of the width of a shadow at the line sensor unit 22U generated by light of the LED 23A, on the coordinate map area MA.

The position detection unit 12 also defines an enclosed area EAc12, which is enclosed by the LED 23C and both ends of the width of a shadow at the line sensor unit 22U generated by light of the LED 23C, on the coordinate map area MA.

Then, the position detection unit 12 determines, as shown in FIG. 12C, that a part of the area where the enclosed area EAb1, the enclosed area EAa12, and the enclosed area EAc12 overlap with one another, and a part of the area where the other enclosed area EAb2, the enclosed area EAa12, and the enclosed area EAc12 overlap with one another as the positions of the objects (1) and (2).

Further, when it is required to identify the positions of the objects (1) and (2) more specifically, the center of the overlapped area PA1 or the center of a circle with a greatest diameter thereof covering the overlapped area PA2 may be considered to be the positions of the objects.

When the line sensor unit 22U detects only one shadow generated by light emitted from the respective LEDs 23A to 23C, there may be only one object placed on the placement space MS.

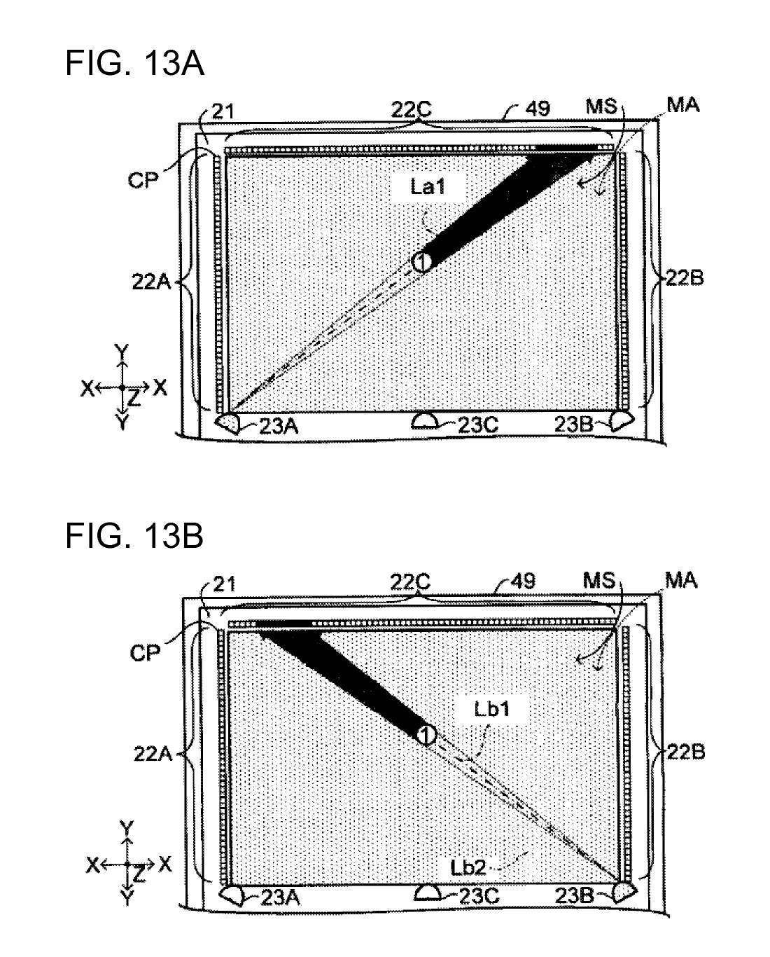

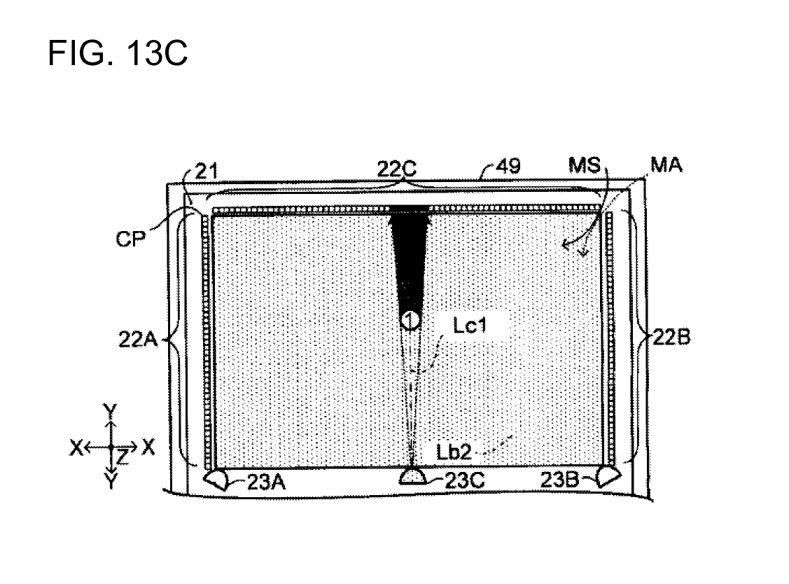

In other words, as shown in FIGS. 13A to 13C, the sensing management unit 14 causes the LEDs 23A to 23C to light up individually as well as sequentially, and counts the shadow of an object (1) generated by light of the respective LEDs 23A to 23C in accordance with light reception data of the line sensor unit 22U. That is, the sensing management unit 14 determines that there are a total of three shadows generated by light of the respective LEDs 23A to 23C (the shadow counting step).

The sensing management unit 14 further sends one identified grid unit data based on light of the LED 23A, one identified grid unit data based on light of the LED 23B, and one identified grid unit data based on light of the LED 23C to the connecting line setting unit 16 (the identified grid unit data setting step).

The connecting line setting unit 16 defines connecting lines L using the identified grid unit data sent from the sensing management unit 14. That is, the connecting line setting unit 16 defines a connecting line La1 according to identified grid unit data based on light emitted from the LED 23A, a connecting line Lb1 according to identified grid unit data based on light emitted from the LED 23B, and a connecting line Lc1 according to identified grid unit data based on light emitted from the LED 23C (the connecting line setting step). The connecting line setting unit 16 then sends data of the three connecting lines to the position identification unit 17.

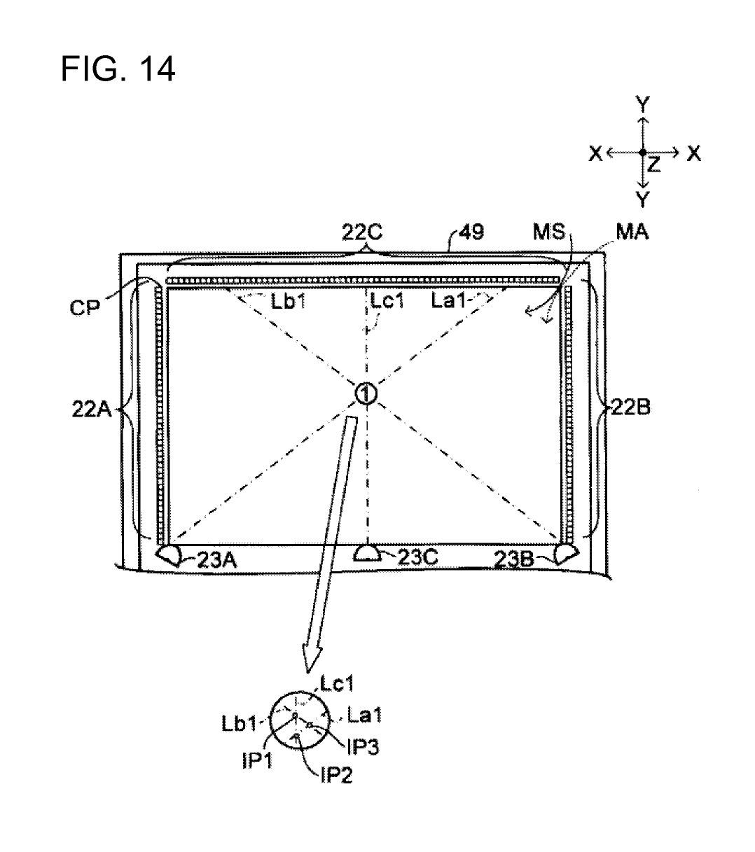

The position identification unit 17 defines intersections of the respective connecting lines L in accordance with the connecting line data sent from the connecting line setting unit 16. Then, as shown in FIG. 14, three intersections IP1 to 1P3 are defined. A place where these intersections are closely located is identified as the position of the object (1) such as a finger (the position identification step).

That is, the position detection unit 12 including the position identification unit 17 determines a part of the area where the intersections IP1 to IP3, which have been created by the connecting line La1 based on the LED 23A, the connecting line Lb1 based on the LED 23B, and the connecting line Lc1 based on the LED 23C, are densely located as the position of one object.

Furthermore, when it is required to identify the position of the object more specifically, the center of a triangle area with the intersections IP1 to IP3 as vertices thereof may be considered as the position of the object (1).

To summarize the foregoing, the position detection unit 12 uses a triangulation method to detect the position of one object (1) or the positions of two objects (1) and (2) on the coordinate map area MA from the changes in the amount of light received (occurrence of the change areas V1 and V2 in light reception data) according to three or more shadows at the line sensor unit 22U that have been generated by light of the plurality of LEDs 23A to 23C illuminating at two objects (1) and (2) placed in the placement space MS (coordinate map space). In other words, the shadows of objects overlapping with the coordinate map area MA, which is enclosed by the line sensor unit 22U, is detected from light reception data of the line sensor unit 22U, and using the data based on the shadows (such as identification grid unit data, connecting line data, enclosed area data), the positions of the objects are detected by a triangulation method.

That is, the position detection system PM including the position detection unit 12 can simultaneously detect (simultaneously recognize) two objects by including, structure-wise (hardware-wise), only the line sensor unit 22U in a “U” shape and three LEDs 23A to 23C (LED unit 23U) arranged at an opening of the “U” shape. Therefore, the liquid crystal display panel 49 equipped with this position detection system PM, that is, the touch panel 49, can recognize gesture movements using two objects (such as fingers).

Moreover, because this touch panel 49 has a relatively simple structure, it is possible to suppress an increase in costs of the touch panel 49, and even of the liquid crystal display device 69 equipped with the touch panel 49.

### Other Embodiments

The present invention is not limited to the above-mentioned Embodiment, and various modifications are possible without departing from the scope of the present invention.

For example, in the above-mentioned embodiment, the number of LEDs 23 included in the LED unit 23U was three, but there is no limitation to this. Four or more LEDs 23 may be included, for example.

In other words, when the LED unit 23U includes P (an integer of three or more) units of LEDs 23 that are placed so as to be mutually spaced apart while facing the line sensor 22C, and those LEDs 23 are being lit sequentially to supply light to the placement space MS, the position detection unit 12 uses a triangulation method to detect the positions of a single or plural objects on the coordinate map area MA from the changes in the amount of light received according to P or more shadows at the line sensor unit 22U that have been generated by light of the plurality of LEDs 23 illuminating at most (P−1) objects such as fingers placed in the placement space MS.

Light of the LED unit 23U enters the line sensor unit 22U through the reflective minor unit 24U, but the reflective mirror unit 24U is not always necessary.

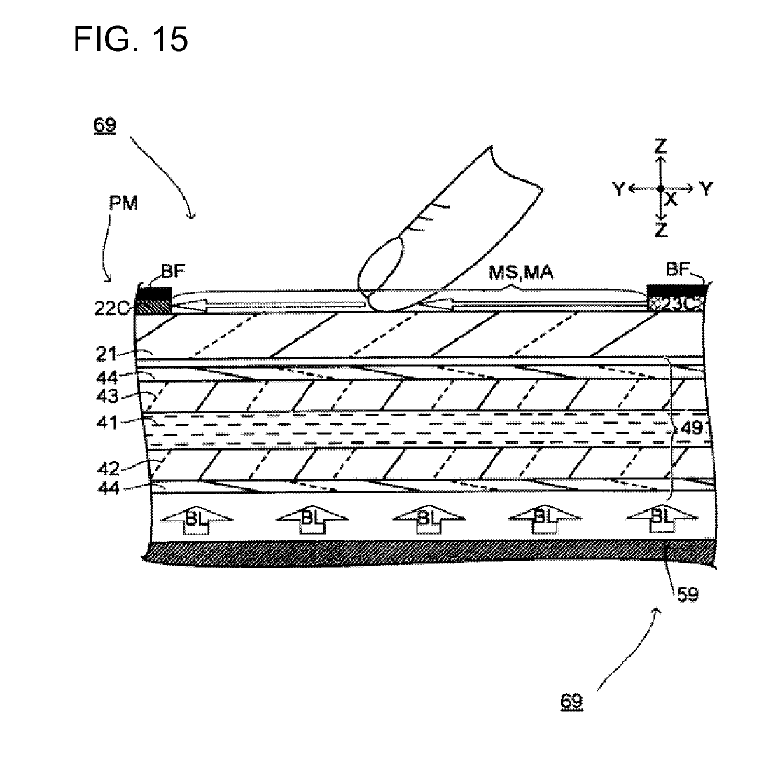

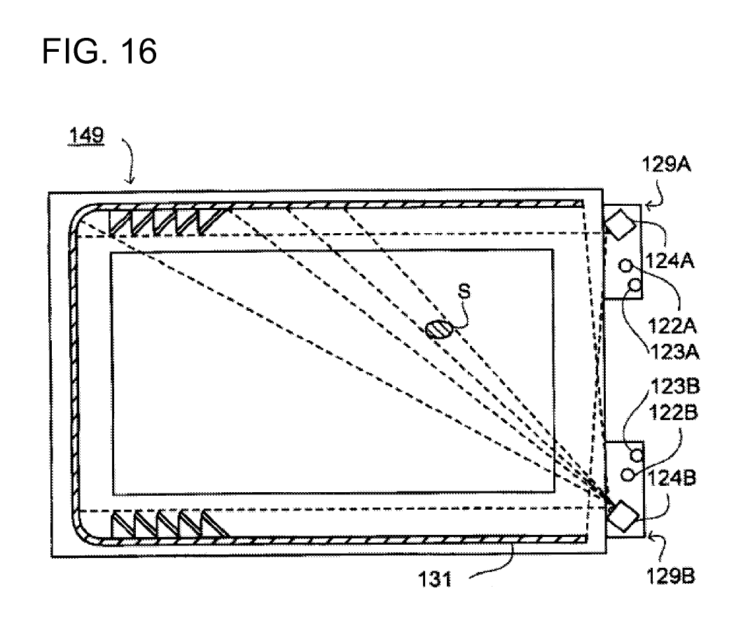

For example, as shown in the cross-sectional view of FIG. 15, the line sensor unit 22U may be placed on the protective sheet 21 so as to receive light from the LED unit 23U without having the light pass through a light reflective member such as the reflective mirror unit 24U. As a result, it is possible to achieve a decrease in costs because the number of members included in the liquid crystal display panel 49 is reduced.

Moreover, in the above-mentioned embodiments, the LEDs 23, which are light emitting elements, have been used as an example of point-like light sources, but there is no limitation to this. A light emitting element such as a laser element, or a light emitting element made of a spontaneous light emitting material such as organic EL (Electro Luminescence) or inorganic EL may be used, for example. Moreover, it is not limited to a light emitting element, and a point-like light source such as a lamp may be used as well.

Further, in the above-mentioned embodiments, the liquid crystal display device 69 has been described as an example of a display device, but there is no limitation to this. The position detection system PM may be mounted in a plasma display device or other display devices such as an electronic black board, for example.

Here, the above-mentioned position detection is achieved by a position detection program. This program is executable with a computer, and may be stored in a recording medium that is readable by a computer. It is because the program stored in a recording medium will be portable.

This recording medium may be a tape-type medium such as a separable magnetic tape and a cassette tape, a disc-type medium of a magnetic disc or an optic disc such as a CD-ROM, a card-type medium such as an IC card (including a memory card) and an optic card, or a semiconductor memory-type medium such as a flash memory, for example.

Moreover, the microcomputer unit 11 may obtain a position detection control program by communication through a communication network. Here, the communication network can be either wired or wireless, and the Internet, infrared data communication or the like may be used.

### INDUSTRIAL APPLICABILITY

The present invention can be used for a position detection system for detecting the position of an object, a display panel equipped with the position detection system (such as a liquid crystal display panel), and further to a display device equipped with the display panel (such as a liquid crystal display device).

### DESCRIPTION OF REFERENCE CHARACTERS

PM Position detection system

11 Microcomputer unit

12 Position detection unit

13 Memory

14 Sensing management unit

15 Enclosed area setting unit

16 Connecting line setting unit

17 Position identification unit

18 LED driver

21 Protective sheet

22 Line sensor (linear light receiving sensor)

22A Line sensor (side-type linear light receiving sensor)

22B Line sensor (side-type linear light receiving sensor)

22C Line sensor (bridge-type linear light receiving sensor)

22U Line sensor unit

23 LED (light source)

23U LED unit (light source unit)

24 Reflective mirror

24U Reflective mirror unit

L Connecting line

EA Enclosed area

IP Intersection

49 Liquid crystal display panel (display panel, touch panel)

59 Backlight unit (illumination device)

69 Liquid crystal display device (display device)

1. A position detection system, comprising:
a light source unit including a plurality of light sources;
a light receiving sensor unit receiving light of said light sources; and
a position detection unit that detects a position of a shielding object, which is blocking light from said light sources, in accordance with changes in an amount of light received at said light receiving sensor,
wherein said light receiving sensor unit includes two side-type linear light receiving sensors that are facing each other, and a bridge-type linear light receiving sensor that bridges between one of said side-type linear light receiving sensors and the other side-type linear light receiving sensor so that a space overlapping with an area enclosed by the linear light receiving sensors is a two-dimensional coordinate map area capable of identifying a position of said shielding object in accordance with said changes in an amount of light received,
wherein said light source unit includes P units (an integer of three or more) of light sources, and the light sources are placed so as to be mutually spaced apart while facing said bridge-type linear light receiving sensor and to supply light to said coordinate map area by way of being lit sequentially, and
wherein said position detection unit uses a triangulation method to detect a position of one or more of said shielding objects on said coordinate map area from said changes in an amount of light received in accordance with P or more shadows at said linear light receiving sensor unit that have been generated by light of the plurality of said light sources illuminating at most (P−1) of said shielding objects placed on said coordinate map area.

2. The position detection system according to claim 1, wherein:
when three of said light sources are lit sequentially, and when a total of three or six of said shadows are generated at said linear light receiving sensor unit in response thereto,
said position detection unit determines as positions of said shielding objects a part of areas where intersections formed by the following three kinds of connecting lines are densely located:
connecting lines that connect one of said three light sources to said shadows at said linear light receiving sensor unit generated by light of said one of said three light sources;
connecting lines that connect another one of said three light sources to said shadows at said linear light receiving sensor unit generated by light of said another light source; and
connecting lines that connect the last one of said three light sources to said shadows at said linear light receiving sensor unit generated by light of said last one of said three light sources.

3. The position detection system according to claim 1, wherein:
when one of said light sources is lit to generate two of said shadows simultaneously at said linear light receiving sensor unit, another one of said light sources is lit to generate two of said shadows simultaneously at said linear light receiving sensor unit, and yet another one of said light sources is lit to generate one said shadow at said linear light receiving sensor unit so that a total of five of said shadows are generated,
said position detection unit determines intersections satisfying the following (1) and (2) as positions of said shielding objects:
(1) intersections generated between (a) two lines of first said connecting lines, which are formed by connecting said one of said light sources simultaneously generating two of said shadows to the corresponding two shadows respectively, and (b) two lines of second said connecting lines, which are formed by connecting said another one of said light sources simultaneously generating two of said shadows to the corresponding two shadows respectively; and
(2) said intersections that overlap with an enclosed area in said coordinate map area that is defined by said yet another light source and the corresponding shadow at said linear light receiving sensor generated by light of said yet another light source.

4. The position detection system according to claim 1, wherein:
when one of said light sources is lit to generate two of said shadows simultaneously at said linear light receiving sensor unit, another one of said light sources is lit to generate one of said shadow at said linear light receiving sensor unit, and yet another one of said light sources is further lit to generate one of said shadow at said linear light receiving sensor unit so that a total of four of said shadows are generated,
said position detection unit determines that a part of an area where one of two first enclosed areas, a second enclosed area, and a third enclosed area overlap with one another, and a part of an area where the other one of said two first enclosed areas, said second enclosed area, and said third enclosed area overlap with one another are respective positions of said shielding objects, where said two first enclosed areas, said second enclosed area, and said third enclosed area are defined as follows:
two enclosed areas in said coordinate map area that are respectively defined by said one of said light sources and the corresponding two shadows at said linear light receiving sensor unit generated by light of said one of the light sources are defined as said two first enclosed areas,
an enclosed area in said coordinate map area that is defined by said another one of said light sources and the corresponding shadow at said linear light receiving sensor unit generated by light of said another one of the light sources is defined as said second enclosed area, and
an enclosed area in said coordinate map area that is defined by said yet another one of said light sources and the corresponding shadow at said linear light receiving sensor unit generated by light of said yet another light source is defined as said third enclosed area.

5. A display panel equipped with the position detection system according to claim 1.

6. A display device equipped with the display panel according to claim 5.
